(19) United States
(12) Patent Application Publication
(10) Pub. No.: US 2025/0086374 A1
(43) Pub. Date: Mar. 13, 2025

(54) METHODS FOR EMBEDDING ELECTRONIC PRESENTATIONS INTO EMAILS AND WEBSITES ON-DEMAND WITH SLIDE AUTOPLAY

(71) Applicant: ORIGIN VENTURES LIMITED, Hong Kong SAR (CN)

(72) Inventors: Tong Li, Toronto (CA); Qianfei Wang, North York (CA)

(73) Assignee: ORIGIN VENTURES LIMITED, Hong Kong SAR (CN)

(21) Appl. No.: 18/599,053

(22) Filed: Mar. 7, 2024

Related U.S. Application Data
(63) Continuation-in-part of application No. 18/466,814, filed on Sep. 13, 2023.

(51) Int. Cl. G06F 40/106; G06F 40/134; G06F 40/14; G06F 40/197

(52) U.S. Cl. CPC G06F 40/106; G06F 40/134; G06F 40/14; G06F 40/197

(57) ABSTRACT

Described are methods and systems to convert electronic presentations into autonomous information collection and feedback systems, with the capability to easily embed the presentation in an email or web page, wherein the presentation starts playing automatically when the email or web page is opened. An electronic presentation file is uploaded and a transcoded version is created in a standard, web compatible multimedia format. Once uploaded, the presentation text and multimedia is also extracted and stored. A multimedia tag in an HTML email or web page has as its source a URL to the remote transcoded version of the presentation. When the email or web page is opened, the transcoded version of the presentation is rendered and played automatically. The transcoded version is also a hyperlink to the full version of the presentation, which is reassembled from the extracted data and displayed directly in the email or web page.

### CROSS REFERENCE TO RELATED APPLICATIONS

This application is a continuation-in-part of U.S. patent application Ser. No. 18/466,814, filed on Sep. 13, 2023, which is incorporated by reference herein for all purposes.

### TECHNICAL FIELD

This disclosure generally relates to methods and systems for creating audiovisual electronic presentations. More particularly, it relates to creating autonomous electronic presentations with the capability of information collection and feedback, and most specifically, embedding such presentations on-demand in web pages and email with automatic starting of the presentation.

### BACKGROUND

Electronic presentations, such as Microsoft PowerPoint files, have become ubiquitous in commerce, education, training, sales and marketing, and other domains of the modern business world.

Electronic presentations may contain digital contents such as text, images, audio, and video, all produced by a presentation publisher. Once produced, presentation slides may be sent or otherwise presented to the intended audience. When sent, such as by email, recipients can open the presentation and then browse through the presentation pages slide-by-slide or watch a self-playing presentation advance through slides automatically. However, electronic presentations have traditionally functioned as a passive document that gets sent around as part of the communication process, or presented to an audience by a speaker with special knowledge of the subject matter. The presentation itself is usually only for viewing purpose, and does not have any information collection or feedback capability. Additional and separate systems and manual steps must be used to collect viewer information or to provide any feedback to viewers. Such additional systems and steps include email surveys, phone calls, in-person and online meetings, web survey systems, calendaring systems, and other manual information collection systems.

Thus, it would be helpful if the electronic presentation itself was a smart, interactive, and autonomous information system that was able to collect viewer input and provide relevant feedback, and allow users to perform a wide range of tasks without using separate systems and doing so anonymously, without interference by the presentation publisher. Some helpful interactive features include asking questions and receiving answers, engaging deeper discussions on the topic, arranging a meeting or follow up with the presentation author or publisher, and other tasks that have traditionally been handled by separate systems or entirely manual processes.

Presentations have traditionally been associated with emails and embedded in web pages by attaching a presentation file to the email (e.g., by SMTP) or by displaying a static hyperlink link on the HTML page or email which links to the presentation located on a remote server. The static link typically displays as an icon or thumbnail representing the presentation or as an image of a single page of the presentation. To view the presentation, the user must first open the presentation by clicking the link and downloading the entire content of the presentation (or downloading the entire email attachment), and then opening and viewing the content. Often, such a link in an HTML email opens in a separate web browser window or opens using a proprietary viewer such as Adobe Acrobat®. Thus, it would also be helpful if presentations could be simply embedded in any HTML email or web page and viewed automatically by dynamically downloading the necessary content and automatically displaying and starting the presentation directly within the email or web page.

### SUMMARY

The methods and systems described herein receive electronic presentation slides and convert those slides into autonomous information collection and feedback systems for embedding and automatically displaying in an email or on a web page. An electronic presentation file is uploaded via a computer network to a Presentation Interpretation System (PIS), where the text and other digital contents are extracted, catalogued, and indexed. The resulting data is stored in an Information Collection and Management System (ICMS), which may include all of the essential data for multiple presentations.

The PIS may also create a transcoded version of the presentation cover page and of the actual slides of the presentation in a standardized media format, such as a Graphics Interchange Format (GIF) image with multiple frames corresponding to each slide, or in a movie format like H.264, both of which are able to play automatically on most email clients and standard web browsers. The transcoded version of the presentation, along with the digital content, are stored in a database in the ICMS.

Upon storing this data, the ICMS also generates a Presentation Embed Code (PEC) which uniquely identifies the presentation among multiple presentations stored in the ICMS database. The PEC may also uniquely identify the presentation's extracted digital content, data regarding how to arrange the digital content, as well as the transcoded version of the presentation created by the PIS.

The extracted digital contents are also sent from the PIS to a Large Language Model System (LLMS), to train the language model and to prepare the LLMS to understand the digital contents and to generate feedback in a human readable language, so as to allow viewers to ask questions and receive appropriate answers, engage in deeper discussions on the topic, or drill down to locate additional information. The LLMS may also include a Benchmark Checker Component to ensure that the feedback is accurate and appropriate.

A Chatbot Component may also be associated with the presentation in order to provide a user interface directly on the slides shown on a viewer's screen, where the user can enter text or provide voice input, which is then transmitted back to the LLMS and where the user can receive relevant responses from the LLMS.

Upon viewing the presentation, viewers may also want to schedule a meeting or follow-up discussion with the presentation author, publisher, or sponsor. Such a meeting or discussion can be either online or offline. A Calendar and Scheduling Component may be displayed on the viewer's screen to present the publisher's calendar and available time slots for the viewer to choose from to schedule the meeting or discussion.

The presentation may be embedded in an HTML email or web page simply by including HTML code in the email or web page that links to a remote server containing the ICMS. This code on the email or web page also includes data associated with the unique PEC of the desired presentation. The PEC also identifies the transcoded version of the presentation created by the PIS, which can be displayed automatically and started immediately when the email or web page is opened and rendered.

The complete presentation may be viewed online, such as by the viewer activating a hyperlink that also includes data associated with the PEC, which directs a web server to reconstitute the complete presentation online, along with the associated Chatbot Component and Calendaring Component in a format that is viewable online by a standard web browser. User chat sessions, meeting requests, and other information may also be collected and stored for later analysis and utilization, such as in improving or supplementing the presentation.

In addition to storing all of the presentation text and audiovisual data, as well as the associated catalogues and indices, the ICMS also stores all of the viewer inputs and any feedback generated by the LLMS, as well as calendar appointments, and basic metrics associated with presentation viewings. This viewer data is useful for many purposes, including to improve the presentation.

The methods and systems described herein thus transform ordinary static presentations into smart, interactive, and autonomous information gathering and reporting systems, which are easily embeddable in emails and web pages and open automatically, are able to collect viewer input and provide relevant feedback, and allow viewers or publishers to perform a wide range of tasks without using separate systems.

### BRIEF DESCRIPTION OF THE DRAWINGS

The disclosed aspects of the systems and methods will hereinafter be described in conjunction with the appended drawings, provided to illustrate and not to limit the disclosed aspects, wherein like designations denote like elements.

FIG. 1 is a schematic illustration of an exemplary system in which the described methods for creating presentations may be performed.

FIG. 2 is a flowchart depicting method steps associated with an exemplary Presentation Interpretation System (PIS) and Information Collection and Management System (ICMS).

FIG. 3 is a flowchart depicting method steps associated with an exemplary Large Language Model System (LLMS).

FIG. 4 is a flowchart depicting method steps associated with an exemplary Calendar and Scheduling Component.

FIG. 5 is a flowchart depicting method steps associated with an exemplary Presentation Rendering and Display System (PRDS).

### DETAILED DESCRIPTION

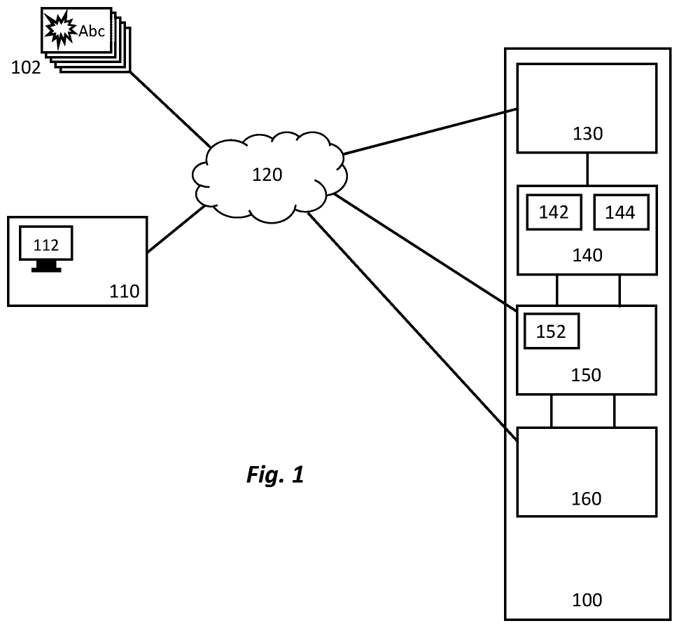

FIG. 1 depicts a system 100 for converting electronic presentations 102 into autonomous information collection and feedback systems. The system 100 includes four major components: (1) a Presentation Interpretation System (PIS) 130, which receives an electronic presentation file 102 through network 120 and extracts the digital contents (text, images, audio, and video), as well as creates a transcoded version of the presentation in a standardized media format; (2) a Large Language Model System (LLMS) 140, which receives viewer questions and generates appropriate responses in a human readable language; (3) an Information Collection and Management System (ICMS) 150, which stores the digital content for presentations, as well as stores various data from the viewing history, such as questions asked by the viewer and responses provided by the LLMS 140; and (4) a Presentation Rendering and Display System (PRDS) 160, which reassembles the digital content stored in the ICMS and displays the content to recreate the appearance of the original presentation using standard media elements viewable on most web browsers or email clients.

Chatbot Component 142 is also associated with the presentation and provides a user interface on screen 112, where the viewer 110 may enter text or provide voice input, which is then transmitted back to the LLMS 140. The Chatbot Component 142 also receives textual responses from LLMS 140 and displays those response on screen 112. The LLMS 140 also includes a Benchmark Checker Component 144 which verifies that the feedback from the LLMS 140 is accurate and appropriate. The Benchmark Checker Component 144 also maintains the session information of the text input and output from LLMS 140.

A Calendar and Scheduling Component 152 is associated with the presentation stored on ICMS 150 and is viewable on the screen 112 so that viewer 110 may schedule a meeting or in-person discussion with the presentation author or publisher. In addition to meeting requests and scheduling information, ICMS 150 also stores all other viewer inputs and the feedback generated by the LLMS 140.

In some embodiments, the PIS 130, ICMS 150, and PRDS 160 are all servers connected to network 120, either separate servers or the same server. The PIS 130 receives the presentation file 102 through the network 120, whereas ICMS 150 and PRDS 160 communicate with the viewer 110 through the network 120. The PIS 130, LLMS 140, ICMS 150, and PRDS 160 are also interconnected for communicating data between the systems and their components.

Unless otherwise indicated, each individual method step performed by system 100 discussed herein is executable on standard processors programmed to perform the method steps on computers or the server(s) of system 100. Each such individual method step may be programmed and implemented in any suitable programming language and environment by a person of ordinary skill in the art with reference to this specification.

Each of the systems and components will now be described in more detail, together with the method steps used to convert electronic presentation file 102 into an autonomous presentation viewable automatically in an email or by any standard web browser, and able to interact with the viewer in a standard human-readable language.

### Presentation Interpretation System (PIS) 130

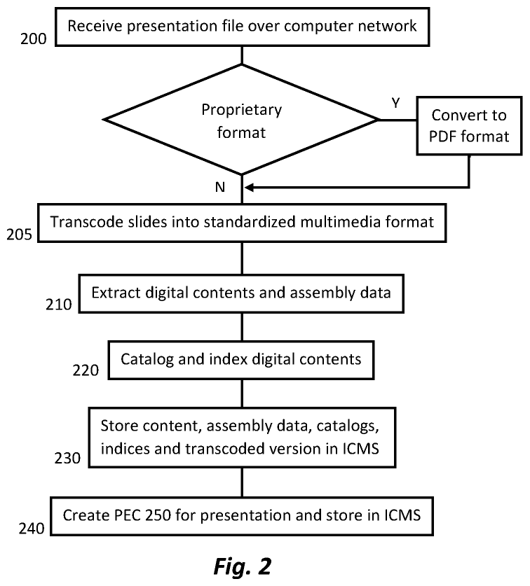

Referring to FIG. 1 and the flowchart of FIG. 2, in step 200, Presentation Interpretation System (PIS) 130 receives an electronic presentation file 102 over computer network 120. The slides in file 102 can be in open source format such as PDF, or proprietary formats such as Microsoft PowerPoint, Apple Keynote, etc. The slides may also be hosted on a remote computer server and accessible via computer networks through network protocols such as HTTP (hypertext transfer protocol) and FTP (file transfer protocol).

In some embodiments, in step 202, slides in a proprietary format may be converted to PDF format using converter software before continuing with the processing. In other embodiments, reader software is used to directly extract the digital contents from the slides received in proprietary formats, without going through the converting process.

In step 205, the slides in the presentation are transcoded into a standardized multimedia format, such as the frames in a Graphics Interchange Format (GIF) image or the sequence of frames in an MP4/H.264 movie file.

In step 210, slides in a non-proprietary format and slides in a PDF format are processed by reader software to extract the digital contents, such as text, images, audio, and video, from the presentation, as well as well as data characterizing how this media should be assembled and displayed as in the original presentation. In step 220, the extracted contents are then catalogued and indexed. The catalogues include tags and classification information concerning the presentation, such as the title and certain texts, as well as subject matter tags (e.g., investment, finance, technology, etc.) so that viewers can effectively search among multiple presentations.

In step 230, the digital contents, assembly data, transcoded version, catalogues, and indices are all stored in an Information Collection and Management System (ICMS) 150.

### Large Language Model System (LLMS)

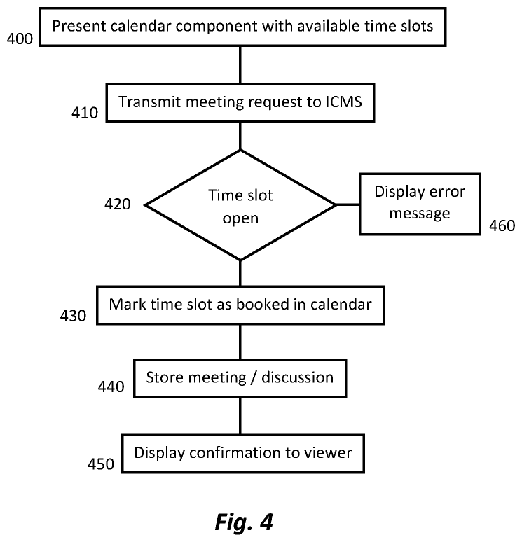

Referring to FIG. 1 and the flowchart in FIG. 3, in step 300, text that was extracted by PIS 130 is provided to Large Language Model System (LLMS) 140 to train it to provide accurate and appropriate responses or feedback concerning the presentation and its topic.

A large language model is a type of artificial intelligence that functions well with human languages. A large language model refers to computer software and hardware systems and algorithms that analyze and tokenize text information and organize the output in human language format. There are two basic types of large language models, proprietary systems such as ChatGPT, and open source systems such as vLLm, Mosaic, or Falcon. LLMS 140 may be either proprietary systems or open source systems.

The LLMS 140 includes a Benchmark Checker Component 144 to verify that answers and other feedback from LLMS 140 are accurate and appropriate. The Benchmark Checker Component 144 is software code that screens responses in step 330 for potential foul or explicit language. In step 340, the Benchmark Checker Component 144 looks up stored responses from previous presentation sessions to determine if the user flagged the response as not useful or otherwise inappropriate. If steps 330 or 340 indicate that the response may be inappropriate, the viewer is presented with an error message in step 360. On the other hand, if steps 330 and 340 do not indicate an inappropriate response, the response is then provided to the viewer in step 350.

The Benchmark Checker Component 144 also maintains the session information of the text input to and output responses from the LLMS 140. At the end of the session, in step 270, the information from the Benchmark Checker Component 144 (input text and corresponding responses and errors) is stored in the Information Collection and Management System (ICMS) 150.

Examples of input and output questions and responses from the LLMS 140 are shown below with respect a presentation titled “Digital Assets and Crypto Report” by Goldman Sachs (Asia) L.L.C. (November 2021):
Q: Who is the author of this presentation?
A: The presentation is authored by Goldman Sachs (Asia) L.L.C. on November 2021.
Q: What are the topics of this presentation?
A: The presentation contains three key agenda: Engaging with Digital Assets and Blockchain Globally How Digital Assets Transform the Financial Infrastructure Space Finding the Opportunities in the Asian Digital Assets Space
Q: Does this presentation contain any case study?
A: Yes. Three companies are selected as case studies. They are: Bullish Circle Coinbase
Q: What is the relationship between the author and Coinbase?
A: The author, Goldman Sachs, served as Financial Advisor to Coinbase and Lead Adviser to NASDQ for Coinbase's public listing on 14 Apr. 2021.
Q: What is Coinbase's IPO opening price?
A: The opening price of Coinbase on NASDAQ on 14 Apr. 2021 was $381.00 US Dollars.
Q: What are the other tech companies which are also advised when going IPO?
A: Goldman Sachs has served as financial advisor for the largest technology direct listings, including Coinbase, Roblox, Palantir, Slack, and Spotify.

### Chatbot Component 142

In FIG. 1, Chatbot Component 142 is depicted as part of the LLMS 140. However, it should be understood that Chatbot Component 142 is actually a client-side software component that appears on the screen 112 and functions as a user interface between the viewer 110 and the LLMS 140. In embodiments, the Chatbot Component 142 is implemented as a scrolling dialog box where the viewer 110 can provide textual input to the LLMS 140 and receive responses or other feedback from the LLMS 140. The viewer's input can be text or it can be voice. The voice input can be transcoded into text via a server-side speech-to-text converter.

Viewer input is transmitted back to the Information Collection and Management System (ICMS) 150 via the computer network 120. ICMS 150 logs and stores the viewer input, and passes the input to the LLMS 140. LLMS 140 then processes the viewer input and provides the feedback to the Benchmark Checker Component 144. If the feedback is accurate and appropriate, it is passed back to ICMS 150, which stores the feedback and then transmits it via the computer network 120 back to the Chatbot Component 142 on screen 112.

If the feedback generated by the LLMS 140 does not pass the Benchmark Checker Component 144, the ICMS 150 still logs and stores the erroneous feedback so that the feedbacks produced by different types of large language models can be compared and the ICMS 150 can potentially choose the best large language model among several options.

### Calendar and Scheduling Component 152

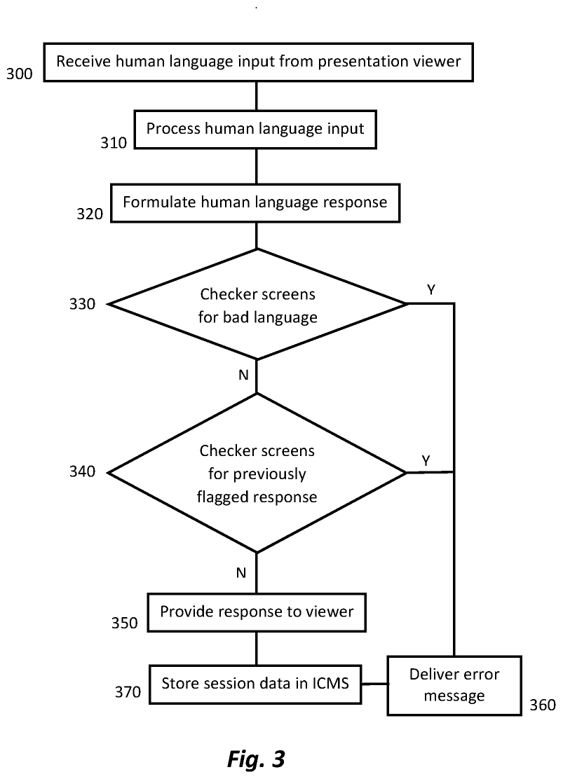

Upon viewing a presentation, a viewer 110 may wish to schedule a discussion or meeting with the presentation author or publisher. This may be common in the case of educational and marketing presentations. As shown in FIG. 1 and the flowchart of FIG. 4, in these situations when the viewer 110 seeks a discussion or meeting with the author or publisher, ICMS 150 may include Calendar and Scheduling Component 152 that operates as a client-side software component. In step 400, the Calendar and Scheduling Component 152 displays a calendar with available time slots on screen 112 so that the viewer 110 of the presentation can schedule a discussion or meeting with the presentation author or publisher.

In step 410, after the viewer 110 chooses a desired time slot, the meeting request is transmitted over the network 120 back to the ICMS 150. In step 420, the Calendar and Scheduling Component 152 checks the time slot availability on first-come-first-served basis or a round-robin basis. If the desired time slot is open, then in step 430, the Calendar and Scheduling Component 152 marks the time slot as booked. In step 440, the Calendar and Scheduling Component 152 logs and stores the meeting or discussion scheduling information in the ICMS 150. In step 450, a confirmation of success is passed back to the viewer 110 via network 120 and the client-side software component which displays the confirmation on screen 112. If the desired time slot is not available, then in step 460, an error message is passed back to the viewer 110.

### Information Collection and Management System (ICMS) 150

As depicted in FIG. 1, in some embodiments, the Information Collection and Management System (ICMS) 150 may be a separate server connected to network 120. The ICMS is also connected to the LLMS 140 to send and receive viewer input and feedback from the LLMS 140. The ICMS 150 is also connected to the PIS 130 to receive extracted data, the transcoded version of the presentation, as well as catalogues and indices generated from the electronic presentation file 102. In other embodiments, the ICMS and one or both of the LLMS 140 and PIS 130 may reside on the same server.

All of the data pertaining to a presentation is received by the ICMS 150 (or generated internally by the ICMS 150), may be stored in a relational database management system (RDMS). To facilitate storing and retrieving all of this data associated with a presentation, when the data associated with a presentation is initially received by the ICMS 150 from the PIS 130 and stored, the ICMS 150 generates a Presentation Embed Code (PEC) 250 to uniquely identify the presentation and all of its associated data. In some embodiments, the PEC 250 may be a short alphanumeric code (e.g., 8-16 characters) that can be used to easily reference the presentation in the URL of a hyperlink. An example is the string “s2C8t22824” used in the following hyperlink:
href=https://www.myserver.com/share/169850?s=s2C8t22824

In this manner, the PEC 250 may be shared easily and still reference a large volume of information associated with a particular presentation.

All of the relevant data generated by the system 100, such as extracted presentation data, the transcoded presentation, assembly data, catalogues, and indices; input from viewer 110; feedback generated by LLMS 140; and meeting scheduling requests and results generated by the Calendar and Scheduling Component 152, are all are logged and stored in the ICMS 150. The ICMS is also accessible by a local or network-accessible management console to view any of the available data. For example, data from the LLMS 140 may be reviewed to gain insights how to improve presentations, and data from Benchmark Checker Component 144 may be reviewed to help choose a more effective large language model to use in the LLMS 140.

### Presentation Rendering and Display System (PRDS) 160

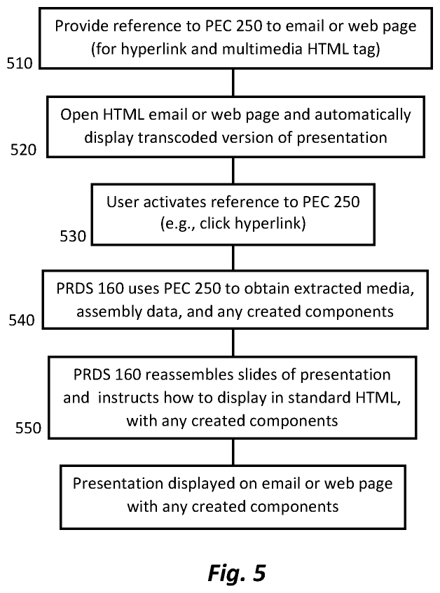

FIG. 5 generally depicts the method steps involved in displaying an electronic presentation in an HTML formatted email or in an HTML web page. In brief overview, the transcoded version of a presentation in a standardized media format (such as .GIF or .MP4) may be embedded in the email or web page by using a standard HTML multimedia tag using a source URL in the email or web page, wherein the multimedia source specified by the URL is displayed automatically as soon as the email or web page is rendered by an email client or by a web browser. The transcoded version of the presentation may lack some of the extended features of the full electronic presentation as discussed above. However, the standardized media format of the transcoded version permits automatically starting the presentation and automatically beginning to display sequential slides as soon as the email or web page is opened and rendered. This autostart feature significantly improves the impact of presentations embedded in emails or web pages, as compared to traditional static presentations. As an exemplary benefit, this improved impact provided by automatically starting the slides of an embedded presentation helps increase the effectiveness of advertising emails or web pages that use the presentation to attract potential customers, such as in advertising presentations in emails sent by real estate agents or brokers.

At step 240 in FIG. 2, the ICMS 150 creates Presentation Embed Code (PEC) 250, which uniquely identifies each presentation and all of its stored data. This PEC 250 or data associated with it may be used in a hyperlink at the desired location of an electronic presentation in the HTML code of an email or web page. For example, the following hyperlink may be placed at this desired location:
<href=https://www.myserver.com/share/169850?s=s2C8t22824.

As noted, the HTML source code for the email or web page may also include a reference to the transcoded version of the presentation in a standardized media format, such as a GIF or movie file. The transcoded version of the presentation may be included in the HTML by using the PEC 250 to query the ICMS 150, either directly or indirectly through the PRDS 160 (which itself communicates with ICMS 150). For example, the following HTML “IMG” tag may be placed at the desired location of the presentation:
<img src=“https://file.myserver.com/transcoded/s2C8t22824.gif”>

In this example, the GIF image is rendered at the specified location and with a particular size, and displays a frame for each of the presentation slides. The frames are automatically rendered as soon as the email or web pages is rendered. The source of the transcoded presentation media file may also be supplied dynamically by using the PEC 250 to query the ICMS 150, either directly or indirectly through the PRDS 160. In this way, the transcoded presentation is automatically played as soon as the HTML email or web page is rendered.

In addition, when the hyperlink including data associated with the PEC 250 is activated by a user, the full interactive version of the presentation is provided to the web page or to the HTML email (or to a newly opened web page as many email clients are programmed to do when activating a hyperlink embedded in an HTML email). This full version of the presentation with one or more of the interactive features as described above is provided by the PRDS 160 by reassembling the extracted components of the original presentation that were stored in ICMS 150, reassembling the components using the extracted assembly data, and by displaying any additional content added by system 100, such as Chatbot Component 142 and Calendar and Scheduling Component 152.

In the example above, referring again to FIG. 5, at step 510, HTML email or web page 512 is provided with a reference to data associated with PEC 250 corresponding to a particular presentation. At step 520, the email or web page 512 is opened, and data associated with the PEC 250 is used to obtain and automatically display the transcoded version of the presentation.

At step 530, a user (viewer 110 in FIG. 1) desiring to view the full presentation activates the hyperlink reference to PEC 250 in the email or web page, which communicates with PRDS 160. At step 540, PRDS 160 uses the data associated with the PEC 250 to obtain the extracted media from the presentation associated with the PEC 250, as well as data characterizing how the media should be reassembled and displayed in the presentation, and any components of the presentation created by system 100. At step 550, PRDS 160 reassembles the media using the data characterizing how the media should be assembled. At step 550, PRDS 160 instructs the email or web page to render the media to create the presentation and to render any additional content created by system 100 specifically for the presentation.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the scope of the invention. Thus, the invention is not intended to be limited to the embodiments shown herein but is to be accorded the widest scope consistent with the principles and novel features disclosed herein.

What is claimed is:

1. A method of creating a presentation comprising the following steps:
receiving an electronic presentation file through a network communication, wherein the electronic presentation file comprises presentation slides with text and audiovisual elements;
extracting the text and audiovisual elements from the presentation slides;
extracting assembly data indicating how the text and audiovisual elements are arranged in the presentation;
creating a transcoded version of the presentation in a standardized multimedia format capable of displaying a plurality of slides of the presentation in a web browser;
storing the extracted text and audiovisual elements, the extracted assembly data, and the transcoded version on a server attached to the network;
creating a presentation embed code that uniquely identifies the presentation, the extracted text and audiovisual elements, the extracted assembly data, and the transcoded version, and storing the presentation embed code on the server; and
receiving data associated with the presentation embed code remotely through the network by the server and returning by the server in response thereto the transcoded version of the presentation associated with the presentation embed code;
wherein the transcoded version of the presentation is configured to be viewable upon opening a remote HTML formatted email or web page.

2. The method of claim 1, further including the following step:
receiving data associated with the presentation embed code remotely through the network by the server and returning by the server in response thereto a second presentation created by the server assembling the extracted text and audiovisual elements into dynamically assembled presentation slides assembled according to the presentation assembly code;
wherein the second presentation created by the server is configured to be viewable remotely over the network by a standard web browser.

3. The method of claim 2, further including the step of providing a chatbot interface along with the dynamically assembled presentation slides over the network, wherein an input and output of the chatbot interface are accessible remotely through the network.

4. The method of claim 2, further including the step of providing a calendar and scheduling component with the dynamically assembled presentation slides, wherein the calendar and scheduling component is accessible remotely over the network.

5. The method of claim 4, further including the following steps:
providing through the calendar and scheduling component, upon a request received through the network, a list of available dates or times associated with the presentation; and
receiving a date or time selected remotely from the list through the calendar and scheduling component.

6. The method of claim 1 further comprising the step of converting the electronic presentation file to a PDF file, and wherein the step of extracting the text and audiovisual elements extracts text and audiovisual elements from the PDF file.

7. The method of claim 1 further comprising the steps of cataloguing and indexing the extracted text and audiovisual elements, and providing remote access to the catalogues and indices through the network to facilitate remotely searching presentations.

8. The method of claim 1, further comprising the following step:
receiving by the server a request for source data of a standard multimedia element, wherein the request includes data associated with the presentation embed code;
wherein the request for source data triggers the step of returning the transcoded version of the presentation.

9. The method of claim 2, further comprising the following steps:
receiving a request by the server for a hyperlink associated with the presentation;
creating a hyperlink to the dynamically assembled presentation slides, wherein the hyperlink includes data associated with the presentation embed code; and
transmitting the hyperlink by the server over the network in response to the request.

10. The method of claim 2, further comprising the following step:
receiving by the server an indication that a hyperlink was activated, wherein the indication of activation includes data associated with the presentation embed code; and
wherein the step of returning the second presentation is triggered by receipt of the indication that a hyperlink was activated.

11. The method of claim 1, further including the following step:
receiving by the server a request for source data associated with a standard HTML multimedia element, wherein the HTML multimedia element indicates a position and size of the multimedia on a web page or an HTML formatted email, and the request for source includes data associated with the presentation embed code.

12. The method of claim 11, wherein the request for source data triggers the step of returning the transcoded version of the presentation.

13. The method of claim 2, further including the following step:
receiving by the server an indication that a hyperlink was activated and the indication of activation includes data associated with the presentation embed code;
wherein the hyperlink is associated with a standard HTML multimedia element, such that clicking on the standard multimedia element activates the hyperlink; and
wherein the step of returning the second presentation is triggered by receipt of an indication that the hyperlink was activated.

14. The method of claim 1, further including the following steps:
training a large language model system (LLMS) with the extracted text;
associating a chatbot interface with the LLMS, the chatbot interface providing an input configured to query the LLMS and an output configured to display feedback from the LLMS; and
providing the chatbot interface along with the dynamically assembled presentation slides over the network, wherein the input and output of the chatbot interface is accessible remotely through the network.

15. The method of claim 14 further comprising the following steps:
storing a plurality of input queries and output feedbacks associated with the chatbot interface when the dynamically assembled presentation slides were viewed remotely; and
providing a management interface to remotely view the stored input queries and output feedbacks over the network.

16. The method of claim 15 further comprising the step of selecting an alternative LLMS based on viewing the stored input queries and output feedbacks associated with the existing LLMS.
